(19) United States
(12) Patent Application Publication
(10) Pub. No.: US 2026/0257671 A1
(43) Pub. Date: Sep. 3, 2026

(54) Automatic Control of a Motor Vehicle

(71) Applicant: Bayerische Motoren Werke Aktiengesellschaft, Muenchen (DE)

(72) Inventors: Dustin Dalton BROWN, Muenchen (DE); Dominik FUESS, Muenchen (DE); Philipp LUTZ, Muenchen (DE); Sebastian REUTER, Muenchen (DE)

(21) Appl. No.: 18/858,415

(22) PCT Filed: May 10, 2023
(86) PCT No.: PCT/EP2023/062380

§ 371 Date: Oct. 21, 2024

(30) Foreign Application Priority Data
May 20, 2022 (DE) 10 2022 112 822.9

(51) Int. Cl. B60W 30/09

(52) U.S. Cl. CPC B60W 30/09; B60W 2510/20; B60W 2520/10; B60W 2552/10; B60W 2554/4044; B60W 2554/802

(57) ABSTRACT

A method for controlling a motor vehicle includes detecting a lane for an oncoming vehicle, identifying a shield between the motor vehicle and the lane, and providing a signal if the shield is inadequate for preventing a collision of the motor vehicle with a potentially incoming vehicle in the lane.

### BACKGROUND AND SUMMARY

The invention relates to the automatic control of a motor vehicle. In particular, the invention relates to switching off an automatic control if there is a risk of collision with an oncoming vehicle.

A motor vehicle comprises a control device for the automatic control of the vehicle. The control device is configured to control the motor vehicle in the longitudinal direction and/or transverse direction and preferably carries out an autonomous control. To avoid an accident, the control of the motor vehicle can take place only when predetermined conditions exist. One of the worst consequences to be imagined of an incorrect control of the motor vehicle can occur if a collision occurs with an oncoming vehicle.

US 2019 0 143 964 A1 proposes executing a last maneuver in case of an upcoming collision of a motor vehicle in order to alleviate consequences of the collision for occupants of the motor vehicle.

One object underlying the invention is to specify an improved technology for securing an autonomously controllable motor vehicle against a collision. The invention achieves this object by the subject of the present disclosure, which also reflects preferred embodiments.

According to a first aspect of the present invention, a method for controlling a motor vehicle comprises steps of detecting a lane for an oncoming vehicle; determining a shield between the motor vehicle and the lane; and providing a signal if the shield is inadequate to prevent a collision of the motor vehicle with a vehicle possibly oncoming on the lane.

The shield can be understood as a physical condition which opposes a collision of the motor vehicle with a vehicle oncoming on the lane, as explained in more detail hereinafter. The shield can be implemented in particular by a structural separation between the lane of the motor vehicle and the lane for an oncoming vehicle. Such a separation is often formed in Europe, for example, by a guide rail or a median strip; a larger free area is often provided in North America. The shield can also comprise another object or another vehicle.

If the shield should not be adequate, the signal can be provided to a human driver or used to initiate a countermeasure. In particular, the driver can be warned of the latent danger. The signal can also request that the driver take over the control of the motor vehicle (takeover request).

If an automatic controller should be active, which is configured to control the motor vehicle, it can be actuated to reduce the hazard or to increase a protection from a consequence of a possible collision. Thus, for example, a lane change to a lane farther away from the oncoming lane can be initiated or a vehicle speed of the motor vehicle can be reduced. Alternatively, the motor vehicle can be controlled into a safe state which can comprise, for example, a slow drive or a standstill.

The automatic controller can be switched off if it is currently active. Switching on of an automatic controller which is not active can be prevented.

The automatic controller is preferably switched off if the shield is more inadequate than predetermined over longer than a predetermined duration and/or over longer than a predetermined distance. This duration can be, for example, several hundred milliseconds, approximately one second, or up to approximately two seconds. An interruption of the adequate shield between the motor vehicle and the oncoming lane can be tolerated, in contrast, if it is shorter than the predetermined duration or distance. The signal then may not be provided and the automatic controller may not be switched off. The determination of a following inadequate cover can be restarted in this case.

The automatic controller is preferably configured to control the motor vehicle in the longitudinal direction and/or in the transverse direction. The automatic controller can meet a degree of automation which may be equivalent to a range between level 1 and level 5 of the SAE standard J3016. The automatic controller is particularly preferably configured for combined longitudinal and lateral control and can carry out the control of the motor vehicle, for example, in case of a traffic jam or on a freeway. The controller can operate on level 3 or higher on the mentioned scale.

It is particularly preferred for a geometric region to be determined with respect to the motor vehicle and an inadequate shield to be determined if the shield fills the region by less than a predetermined amount. It can thus be established in a simple manner whether there is a realistic risk that the motor vehicle will collide with a vehicle potentially driving on the oncoming lane. The region moves together with the motor vehicle; its occupancy can give information about a currently prevailing risk of collision.

In a first embodiment, the occupancy of the area of the geometric region can be evaluated by a shield. For example, a deficient shield can exist if the area of the region is occupied by less than 40%. In a further embodiment, the filling of the region by a shield can be determined in the manner of a projection. If an object is located between the motor vehicle and the oncoming lane, for example, not only the area occupied by the object but also the part of the region which is located behind the object from the motor vehicle can be counted as occupied.

The region preferably extends in the horizontal direction on an underlying surface. The region preferably adjoins the motor vehicle or begins at a predetermined, small distance of, for example, approximately 0.5 to approximately 1 m.

The region can be determined in dependence on a current driving speed of the motor vehicle. If the driving speed is low, the region can extend more in the lateral direction from the motor vehicle, for example. The higher the vehicle speed is, the farther in the direction of travel the region can be directed. In addition, an extension of the region from the motor vehicle can be enlarged with increasing driving speed. A width of the region can also be adapted.

In a further embodiment, the region is determined in dependence on a steering capacity of the motor vehicle. It can thus be taken into consideration that driving dynamics possible due to the driving condition and the design of the motor vehicle only permit a certain movement of the motor vehicle. For example, a minimal curve radius of the motor vehicle can increase with increasing driving speed. The region can be adapted in such a way that a risk of collision for a location which the motor vehicle cannot reach due to its steering capacity is not taken into consideration.

In still a further embodiment, the region can be determined in dependence on an acceleration capacity of the motor vehicle. It can thus be taken into consideration that the motor vehicle cannot reach a vehicle driving on the oncoming lane if an acceleration is required for this purpose which cannot be achieved by a drivetrain of the motor vehicle in the present driving conditions. In a similar manner, the region can also be determined with respect to a deceleration capacity of the motor vehicle. The region can be adapted in each case here so that locations not at risk of collision are removed from the consideration.

In still another embodiment, the region is determined in such a way that it contains locations to which the motor vehicle can be controlled within a predetermined time. For example, the region can be determined in such a way that it comprises all locations which can be reached within the predetermined time, for example, approximately 1 to 2 seconds. Locations which the motor vehicle cannot reach within this time cannot be located in the region. Realistic restrictions can be taken into consideration with respect to the ability of the motor vehicle to reach a location. These can in particular relate to the mentioned steering capacity, acceleration capacity, or deceleration capacity of the motor vehicle. The shield is preferably not yet taken into consideration for the determination of the reachable locations.

The shield between the motor vehicle and the oncoming lane can be formed in different ways.

In a first variant, the shield comprises a further vehicle which drives in the same direction as the motor vehicle between the motor vehicle and the oncoming lane.

Such a situation can be present, for example, on a freeway, where the motor vehicle is underway on a slow lane and the vehicle driving in the same direction is underway on a faster lane. The larger the other vehicle is, the stronger its shielding effect on the oncoming lane can be. The closer the driving speed of the other vehicle driving in the same direction is to the driving speed of the motor vehicle, the longer the shielding effect on the motor vehicle can last.

In a second variant, the shield comprises a structure. A stationary object, the height of which exceeds a predetermined threshold value, can be considered a structure. In a further embodiment, only an object which has a predetermined resistance force to the motor vehicle or an oncoming vehicle is viewed as a structure. For this purpose, for example, a height, a deformability, a displaceability, a material, a shape, or a mass of the object can be taken into consideration. A plastic marker which can be set up in the area of a construction site may not be considered a structure in this meaning, but a parked construction machine or an earth wall can be.

In a third variant, the shield comprises a free area of a predetermined size. An object located on the area can remain unconsidered if it is not recognized as a structure.

According to a second aspect of the present invention, a device for controlling a motor vehicle comprises a first sensor and/or a source of map information (such as a memory having map data) for identifying a lane for an oncoming vehicle; a second sensor for detecting the surroundings of the motor vehicle; and a processing device. The processing device is configured for determining a shield of the motor vehicle from the lane on the basis of data which are provided by the first sensor and/or the source of map information and by the second sensor; and furthermore to provide a signal if the shield cannot prevent a collision of the motor vehicle with a vehicle possibly oncoming on the lane. It is to be understood here that the signal can be generated independently of whether a vehicle is actually oncoming; rather the suitability in principle of the shield for preventing a collision of the motor vehicle with an oncoming vehicle (if a vehicle should be oncoming) is decisive.

The processing device is preferably configured to entirely or partially carry out a method described herein. For this purpose, the processing device can comprise a programmable microcomputer or microcontroller. The method can be provided in the form of a computer program product having program code. The computer program product can also be stored on a computer-readable data carrier. Features or advantages of the method can be transferred to the device or vice versa.

It is to be noted that the first and the second sensor can also be integrated with one another or can be identical to one another. In practical terms, any arbitrary number of sensors can be used to detect the oncoming vehicle or to scan the surroundings of the motor vehicle.

According to still another aspect of the present invention, a motor vehicle comprises a device for automatic control, as well as a device described herein.

The invention will now be described in more detail with reference to the appended drawings.

### BRIEF DESCRIPTION OF THE DRAWINGS

FIG. 1 illustrates a system having a motor vehicle;

FIG. 2 illustrates a control device on board a motor vehicle; and

FIG. 3 illustrates a flowchart of the method.

### DETAILED DESCRIPTION OF THE DRAWINGS

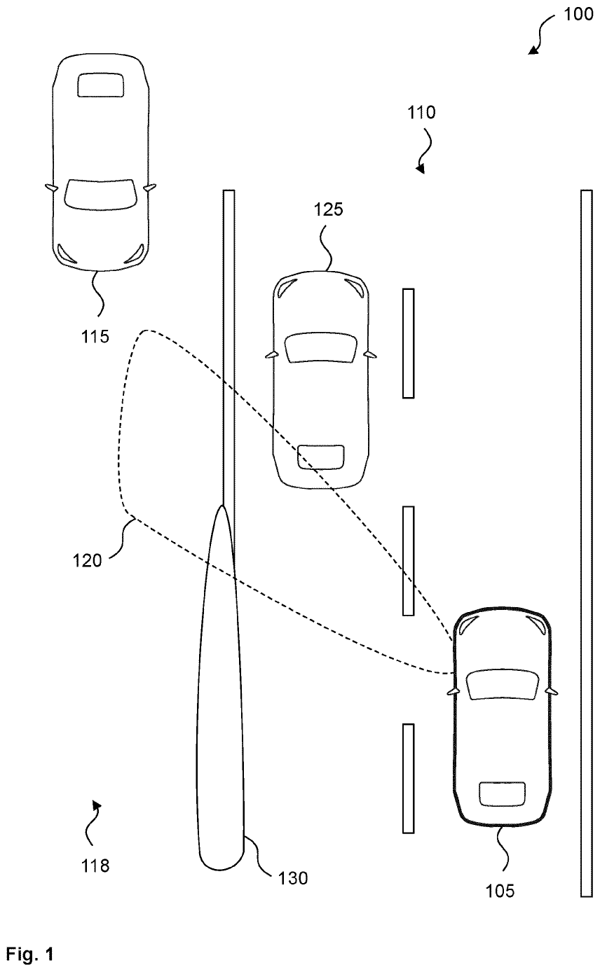

FIG. 1 shows a system 100 having a motor vehicle 105, which travels on a road 110. Since the following observations often take place from the motor vehicle 105, it can also be called EGO vehicle 105 or EGO motor vehicle 105. Another vehicle 115 can travel on a lane 118 in a direction which runs essentially opposite to the direction of travel of the motor vehicle 105. The oncoming vehicle 115 is typically also a motor vehicle. If the vehicle 115 should be stationary, it can be determined as not oncoming. The lane 118 can be part of the road 110 or another road.

The motor vehicle 105 can be controlled in its movement by an automatic control device. The control device can control the motor vehicle in the longitudinal direction and/or in the transverse direction. To prevent a collision from being able to occur between the motor vehicle 105 and a vehicle 115 possibly traveling on the oncoming lane 118 even in the event of an error of the automatic control device, the automatic controller or the control device can be switched off if a predetermined condition is not met.

It is proposed that this condition comprises the size or thickness of a shield which is located between the motor vehicle 105 and the oncoming lane 118 and which can make a collision with a potentially oncoming vehicle 115 less probable or less serious. For this purpose, it is furthermore proposed that a region 120 be determined with respect to the motor vehicle 105 and then an amount or degree be determined by which the region 120 is filled with a shield.

The region 120 extends, roughly speaking, between the motor vehicle 105 and the oncoming lane 118. A shape and size of the region 120 is preferably predetermined, but can also be dynamically determined. In the illustrated embodiment, the region is shaped like a lobe; in other embodiments, the region 120 can, for example, assume the shape of a rhomboid, a trapezoid, a rectangle, or a circular segment, other shapes are also possible.

The region 120 extends along a longitudinal axis which typically encloses an acute angle with the direction of travel of the motor vehicle 105. A width of the region 120 can be determined perpendicular to its length. A direction of the longitudinal axis, a length, and/or a width can be determined like the shape in dependence on a driving state of the motor vehicle 105.

The illustration of FIG. 1 is based on the assumption that the oncoming lane 118 leads past the motor vehicle 105 on the left. This is typically the case if right hand traffic prevails in the system 100 and a potentially oncoming vehicle 115 uses the oncoming lane 118. The region 120 therefore extends from the motor vehicle 105 to the left. In other constellations, however, the region 120 can also extend from the motor vehicle 105 to the right. Regions 120 can optionally be observed on both sides of the motor vehicle 105.

The region 120 can be covered in different ways. In a first variant, a section of another vehicle 125, which generally comprises another motor vehicle, is located in the region 120. This typically presumes that the other vehicle 125 moves essentially between the motor vehicle 105 and the oncoming lane 118 in a direction which extends parallel to the direction of travel of the motor vehicle 105. The other vehicle 125 can also travel slower or faster than the motor vehicle 105 in this case.

The region 120 can also be covered by a structure 130. A structure 130 is understood as a structural measure, a terrain feature, a thing, an object, or a section of the road 110 which is configured to stop a movement of the motor vehicle 105 in the direction of the oncoming vehicle 115. In a first approximation, it can be presumed that this is the case for any structure 130 which is larger than a predetermined minimum size. The size can comprise a height in the vertical direction and/or a cross section determinable from the motor vehicle 105.

In a refinement, it can also be checked whether the structure 130 would be sufficiently resistant to a movement of the motor vehicle 105 or a vehicle 115. An object class of the structure 130 can be determined for this purpose. Only objects which are in predetermined object classes can be accepted as a structure 130. Examples of such object classes comprise a guide rail, a bridge pier, or a drainage trench.

In a third variant, the region 120 is covered by a free area of a predetermined size. The free area can counteract a movement of the motor vehicle 105 toward the oncoming vehicle 115 like a buffer zone or a gravel bed.

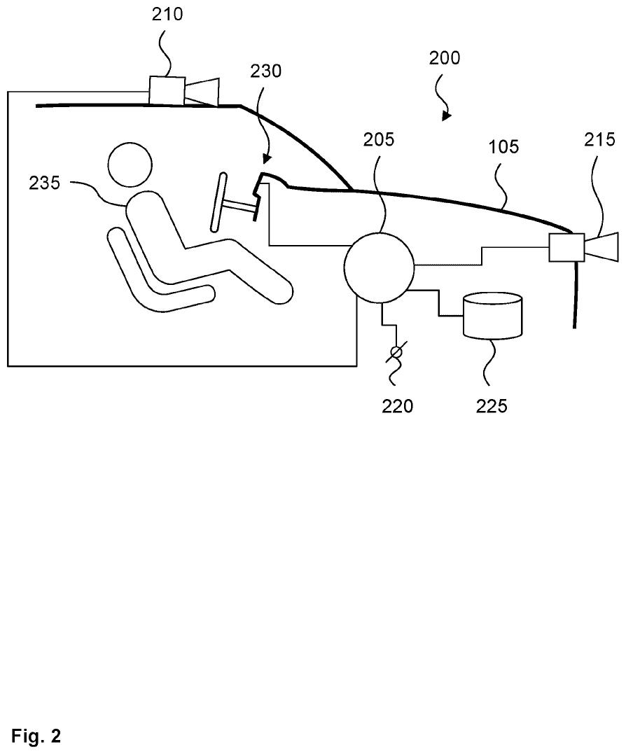

FIG. 2 shows a control device 200 onboard a motor vehicle 105. The control device 200 comprises a processing device 205, a first sensor 210, an optional second sensor 215, an interface 220, and optionally a data memory 225 and/or an output device 230.

The first sensor 210 comprises, for example, a camera and is configured to scan the surroundings of the motor vehicle 105. The second sensor 215 comprises, for example, a radar or LIDAR sensor. The surroundings of the motor vehicle 105 can also be detected by the second sensor 215. Sensor signals are provided here, which can be evaluated by the processing device 205 in order to determine an oncoming vehicle 115 or a cover in the area of the motor vehicle 105.

A signal can be provided via the interface 220, in order to switch off an automatic control device for the motor vehicle 105. In order that the motor vehicle 105 is not moved in a driverless manner, a request can be provided to a driver 235 by the output device 230 to take over the control of the motor vehicle 105.

Information can be stored in the data memory 225, which permits the processing device 205 to identify an oncoming vehicle 115, another vehicle 125, a structure 130, or a free area in the surroundings of the motor vehicle 105.

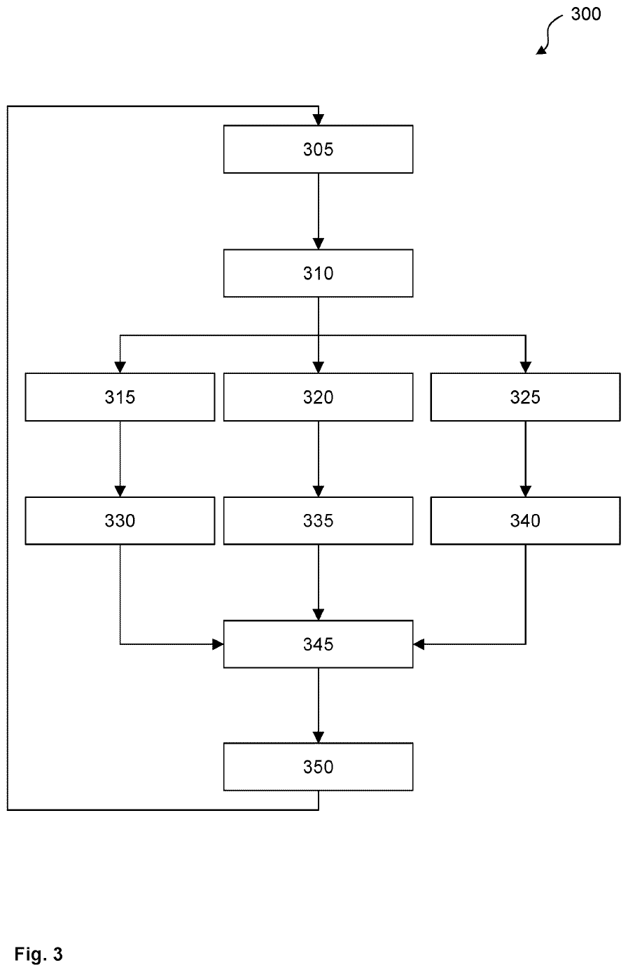

FIG. 3 shows a flow chart of a method 300 which is preferably carried out by a system 100 onboard a motor vehicle 105.

In a step 305, the surroundings of the motor vehicle 105 can be detected by the sensors 210, 215. An oncoming lane 118 can be determined on the basis of the detected sensor data in a step 310. In another embodiment, the oncoming lane can also be determined on the basis of a geographic position of the motor vehicle 105 and map data in the area of the determined position. If no oncoming lane 118 is present within a predetermined distance from the motor vehicle 105, the method 300 can terminate or return to the beginning. In addition, the region 120 can be defined in step 310, the size, orientation, or shape of which can be dependent on a driving state of the motor vehicle 105.

Different coverages of the region 120 can now be determined in dependence on the sensory detection in step 305 and the region 120 defined in step 310. The different coverages can be individually treated or weighted and then brought together.

In a step 315, another vehicle 125 can be determined, at least a section of which is located in the region 120. The other vehicle 125 is located essentially between the motor vehicle 105 and the oncoming lane 118.

In a step 320, a structure 130 can be determined, at least one section of which is located in the region 120. Optionally, it can be determined for an object in the surroundings of the motor vehicle 105 whether it meets predetermined criteria in order to be considered a structure 130. In addition, it can be determined whether an identified structure 130 has a predetermined minimum size.

In a step 325, a free space or a free area in the surroundings of the motor vehicle 105 can be determined. The free space preferably forms a contiguous area of a predetermined size. The area can have a predetermined minimum length and/or a predetermined minimum width. In different embodiments, the size of the free area can be determined as a whole or within the region 120. The free space can only be taken into consideration as a shield when the size within the region 120 exceeds a predetermined threshold value.

In a step 330, it can be determined which part of the region 120 is filled by the other vehicle 125. In a corresponding manner, it can be determined in a step 335 which part of the region 120 is filled by the structure 130 and in a step 340, which part of the region 120 is filled by the free area.

In a step 345, it can be determined whether a shield between the motor vehicle 105 and oncoming lane 115 is sufficient. This can be the case if the predetermined region 120 is filled by a predetermined part. In one variant, the filled parts which were determined in steps 330, 335, and 340 are added up for this determination. A part which is filled multiple times can only be assessed once in this case.

Furthermore, it is preferably determined whether this condition is not met over a predetermined duration or over longer than a predetermined distance. This duration can be, for example, approximately 1 to approximately 3 seconds. If the region 120 is not filled by a predetermined amount or the region 120 is not filled by the predetermined amount longer than the predetermined duration or distance, in a step 350, a warning can be provided to the driver 235. The control device of the motor vehicle 105 can be switched off delayed by a predetermined time or also immediately. If the control device should not be active at this point in time, switching on of the device can be prevented. The warning of the driver 235 can then also be omitted.

The method 300 can then return to the beginning and run through the sequence again.

### List of Reference Signs

100 system
105 motor vehicle
110 road
115 oncoming vehicle
120 region
125 other vehicle
130 structure
200 control device
205 processing device
210 first sensor
215 second sensor
220 interface
225 data memory
230 output device
235 driver
300 method
305 detect surroundings
310 define region, determine oncoming traffic
315 determine other vehicle
320 determine structure
325 determine free space
330 determine coverage
335 determine coverage
340 determine coverage
345 shield adequate?
350 provide warning

1-12. (canceled)

13. A method for controlling a motor vehicle comprising:
identifying a lane for an oncoming vehicle;
determining a shield between the motor vehicle and the lane; and
providing a signal in response to the shield being determined to be inadequate to prevent a collision of the motor vehicle with a vehicle possibly oncoming in the lane.

14. The method according to claim 13, comprising:
controlling, on a basis of the signal, an automatic controller that is configured to control the motor vehicle.

15. The method according to claim 14, comprising:
switching off, or preventing a switching on, of the automatic controller.

16. The method according to claim 13, comprising:
providing the signal in response to the shield being determined to be inadequate to prevent the collision over longer than a predetermined duration and/or longer than a predetermined distance.

17. The method according to claim 13, comprising:
determining a geometric region with respect to the motor vehicle; and
determining an inadequate shield in response to determining that the shield fills the geometric region by less than a predetermined amount.

18. The method according to claim 17, comprising:
determining the geometric region in dependence on a current driving speed of the motor vehicle.

19. The method according to claim 17, comprising:
determining the geometric region in dependence on a steering capacity of the motor vehicle.

20. The method according to claim 17, comprising:
determining the geometric region in such a way that it contains locations to which the motor vehicle can be controlled within a predetermined time.

21. The method according to claim 13,
wherein the shield comprises another vehicle that travels between the motor vehicle and the lane in a same direction as the motor vehicle.

22. The method according to claim 13, wherein the shield comprises a structure.

23. The method according to claim 13, wherein the shield comprises a free area of a predetermined size.

24. A device for controlling a motor vehicle, the device comprising:
a first sensor and/or a source of map information configured to identify a lane for an oncoming vehicle;
a second sensor configured to detect surroundings of the motor vehicle; and
a processing device configured to:
determine a shield of the motor vehicle from the lane on a basis of data that is provided by the first sensor and/or the source of map information and by the second sensor; and
provide a signal in response to determining that the shield cannot prevent a collision of the motor vehicle with a vehicle possibly oncoming on the lane.

25. The device according to claim 24,
wherein the processing device is configured to:
control, on a basis of the signal, an automatic controller that is configured to control the motor vehicle.

26. The device according to claim 25,
wherein the processing device is configured to:
switch off, or prevent a switching on, of the automatic controller.

27. The device according to claim 24,
wherein the processing device is configured to:
provide the signal in response to the shield being determined to be inadequate to prevent the collision over longer than a predetermined duration and/or longer than a predetermined distance.

28. The device according to claim 24,
wherein the processing device is configured to:
determine a geometric region with respect to the motor vehicle; and
determine an inadequate shield in response to determining that the shield fills the geometric region by less than a predetermined amount.

29. The device according to claim 28,
wherein the processing device is configured to:
determine the geometric region in dependence on a current driving speed of the motor vehicle.

30. The device according to claim 28,
wherein the processing device is configured to:
determine the geometric region in dependence on a steering capacity of the motor vehicle.

31. The device according to claim 28,
wherein the processing device is configured to:
determine the geometric region in such a way that it contains locations to which the motor vehicle can be controlled within a predetermined time.

32. The device according to claim 24,
wherein the shield comprises another vehicle that travels between the motor vehicle and the lane in a same direction as the motor vehicle.
